(19) United States
(12) Patent Application Publication
(10) Pub. No.: US 2025/0304759 A1
(43) Pub. Date: Oct. 2, 2025

(54) ADDITIVES FOR HEAT-TREATED FOAMABLE POLYPROPYLENE

(71) Applicant: FINA TECHNOLOGY, INC., Houston, TX (US)

(72) Inventors: Michael A. McLeod, Houston, TX (US); Ngoc Niikky Nguyen, Houston, TX (US)

(73) Assignee: FINA TECHNOLOGY, inc., Houston, TX (US)

(21) Appl. No.: 19/236,249

(22) Filed: Jun. 12, 2025

Related U.S. Application Data
(62) Division of application No. 17/964,430, filed on Oct. 12, 2022.

(51) Int. Cl. C08J 9/12; C08J 9/14; C08L 23/12

(52) U.S. Cl. CPC C08J 9/122; C08J 9/141; C08L 23/12; C08J 2203/06; C08J 2203/14; C08J 2323/12; C08J 2423/12; C08L 2205/025; C08L 2310/00

(57) ABSTRACT

A composition including a first polypropylene having at least 90 wt. % propylene by weight of the first polypropylene, an alpha nucleation inhibitor, and a beta nucleation additive is provided. Also provided is a method of preparing a foamable polypropylene composition. The method includes the steps: a) compounding a first polypropylene including at least 90 wt. % propylene by weight of the first polypropylene with an alpha nucleation inhibitor to form a polypropylene blend; b) compounding the polypropylene blend with a blowing agent to form a pre-annealed polypropylene composition; and c) annealing the pre-annealed polypropylene composition at an annealing temperature Ta for an annealing time ta to form the foamable polypropylene composition. The foamable polypropylene composition has a first melting peak T1 and a second melting peak T2 as measured by differential scanning calorimetry at a heating rate of 20° C. per minute.

### CROSS-REFERENCE TO RELATED APPLICATIONS

This application is a divisional application of U.S. Nonprovisional patent application Ser. No. 17/964,430, filed on Oct. 12, 2022, and entitled “ADDITIVES FOR HEAT-TREATED FOAMABLE POLYPROPYLENE”, the entirety of which is incorporated herein by reference.

### FIELD OF THE INVENTION

The invention relates to a polypropylene composition useful for foamable applications.

### BACKGROUND

Expanded Polypropylene (EPP) is an engineered plastic foam useful for many applications. Polypropylene offers many attributes that make it preferred in some engineered plastic foam applications. Its high temperature resistance compared to other polymers such as polyethylene and polystyrene, high energy absorption, low weight and high thermal stability are some attractive characteristics. These characteristics may become more important if certain polymers, e.g., polystyrene, become less desirable due to regulatory restrictions, cost, and/or recycling challenges. Other desirable attributes of foamed polypropylene are high ratio of weight to energy absorption, excellent repetitive impact performance, excellent temperature resistance, high durability, and its ease of recycling. Additionally, polypropylene can include recycled content, has low or zero VOC content; is non-toxic and suitable for food contact; is resistant to oil, chemical and weather, is flexible, returns to original shape after static or dynamic loading—i.e., is creep resistant-its expansion ratio is easily adjustable, it has low water absorption, and is an insulator to both heat and electricity.

The typical method of generating EPP includes:

1) Incorporate a blowing agent into polypropylene and produce small plastic beads that incorporate the blowing agent. The blowing agent typically is either carbon dioxide or a low molecular weight alkane such as n-butane or n-pentane. The incorporation method is done by applying heat, pressure and the gas (e.g. carbon dioxide or alkane) in an autoclave to polypropylene pellets, forming small plastic beads infused with the gas.

2) These gas-infused beads are then placed into a mold and placed into a steam chest to heat the beads, thereby sintering them to create foamed parts molded into complex shapes.

Key to this process is the first step, the autoclaving step, because it transforms the crystalline morphology of polypropylene. Traditional EPP uses a random propylene/ethylene copolymer PP (RCP) having a single melting point at about 145° C. (see FIG. 1). By keeping the RCP at a constant temperature and pressure, and then cooling it, the melting point is transformed into two separate peaks, typically around 140° C. and 160° C. (see FIG. 2). The lower melting peak is attributed to beta crystallites and the higher melting peak is attributed to alpha crystallites. This “double crystal structure” or “double peak” technology is required for good sintering in the second step in the steam chest. The low melting beta species are needed to create good adhesion between the beads while the high melting temperature alpha crystals maintain the overall foam structure during the sintering process. The steam chest temperature is therefore between the local minima (between the two melting peaks).

However, there are at least two current drawbacks to the present method of producing EPP. First, the autoclaving step is expensive and slow, thus rendering production of the beads an expensive proposition. If the gas could be incorporated more rapidly, such as by melt compounding and then the beads merely annealed to provide the double peak melting behavior, without the need for the autoclave, the production of the beads would then be more efficient. Second, a wider temperature difference between the two melting peaks would require less thermal control during the second, steam chest step, therefore providing a more flexible, robust production process for the EPP foamed parts.

### SUMMARY

The present inventors have solved these problems by providing a polypropylene composition that includes both a beta nucleation additive and an alpha nucleation inhibitor. This polypropylene composition provides at least two melting peaks with a wider separation between the peaks. The inventors have also provided a method of producing a polypropylene composition that has (at least) double peak melting behaviour that does not require the use of the autoclave, but that can be produced by other (including more conventional) polymer compounding techniques and then annealing.

A composition comprising a first polypropylene comprising, as polymerized monomers, at least 90 wt. % propylene by weight of the first polypropylene, an alpha nucleation inhibitor, and a beta nucleation additive is provided.

A method of preparing a foamable polypropylene composition is also provided. The method comprises the steps:
a) compounding a first polypropylene comprising, as polymerized monomers, at least 90 wt. % propylene by weight of the first polypropylene with an alpha nucleation inhibitor to form a polypropylene blend;
b) compounding the polypropylene blend with a blowing agent to form a pre-annealed polypropylene composition; and
c) annealing the pre-annealed polypropylene composition at an annealing temperature Ta for an annealing time ta to form the foamable polypropylene composition. The foamable polypropylene composition has a first melting peak T1 and a second melting peak T2 as measured by differential scanning calorimetry at a heating rate of 20° C. per minute.

### BRIEF DESCRIPTION OF THE FIGURES

FIG. 1 shows melting behavior of unannealed random copolymer polypropylene (RCP);

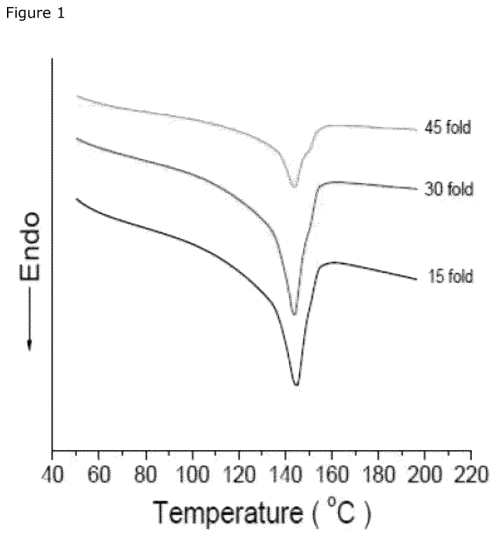

FIG. 2 shows melting behavior of annealed random copolymer polypropylene (RCP);

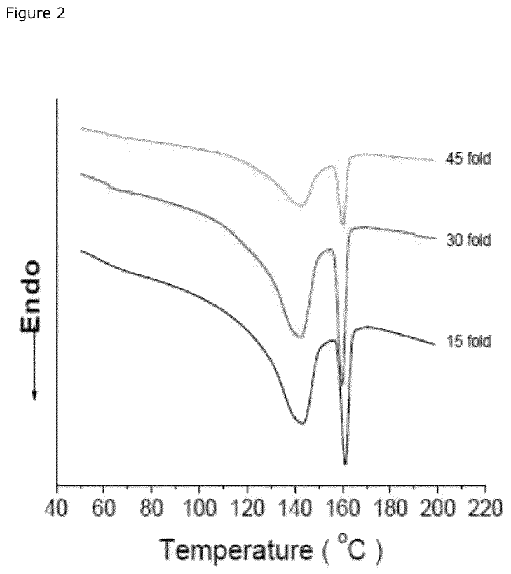

FIG. 3 shows comparative Example 1 second DSC traces for various annealing temperatures;

FIG. 4 shows Example 1 second melt DSC traces for various annealing temperatures;

FIG. 5 shows Example 1, expanded view of higher melting peak 160° C. to 190° C. DSC traces;

FIG. 6 shows Example 2 second melt DSC traces for various annealing temperatures;

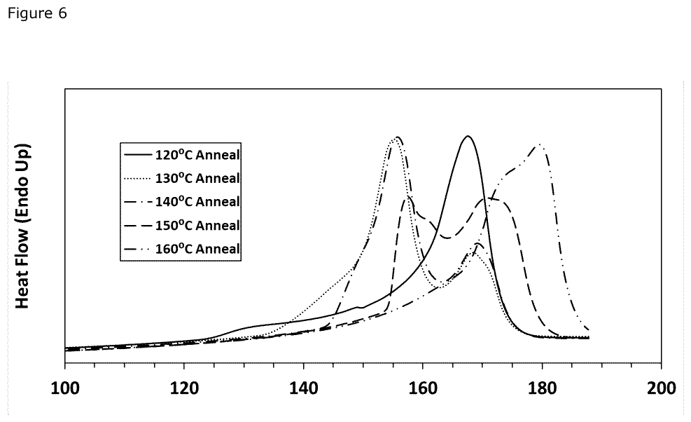

FIG. 7 shows Example 3 second melt DSC traces at various annealing temperatures;

FIG. 8 shows second melt DSC traces of Comparative Example 1, and Examples 1, 2, and 3, at annealing temperature of 150° C.;

FIG. 9 shows second melt DSC traces for Examples 1, 2, and 3 at an annealing temperature of 160° C., with endset melting temperature for Comparative Example 1 shown for reference;

FIG. 10 shows Comparative Example 2 Annealed Ziegler Natta catalyzed random copolymer (propylene/ethylene copolymer) alone;

FIG. 11 shows second melt DSC traces for annealed Example 4;

FIG. 12 shows second melt DSC traces with 150° C. annealing for Comparative Example 2 and Example 4;

FIG. 13 shows second melt DSC traces for annealed Example 5;

FIG. 14 shows second melt DSC traces with 150° C. annealing for Comparative Example 2 and Example 5;

FIG. 15 shows second melt DSC traces for annealed Example 6;

FIG. 16 shows second melt DSC traces with 150° C. annealing for Comparative Example 2 and Example 6;

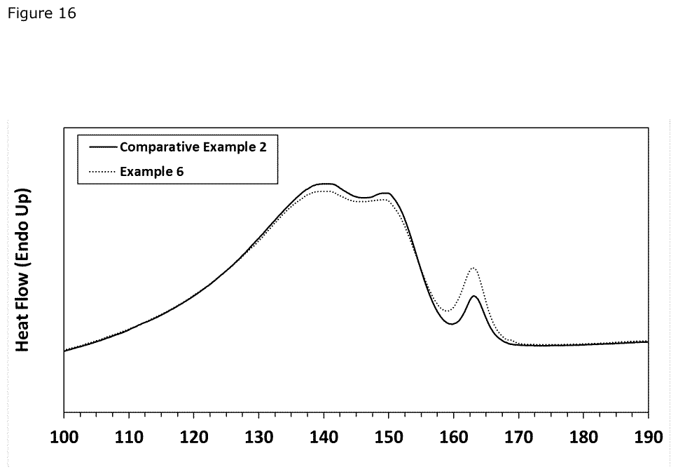

FIG. 17 shows second melt DSC traces with 130° C. annealing for Example 4 and Example 6;

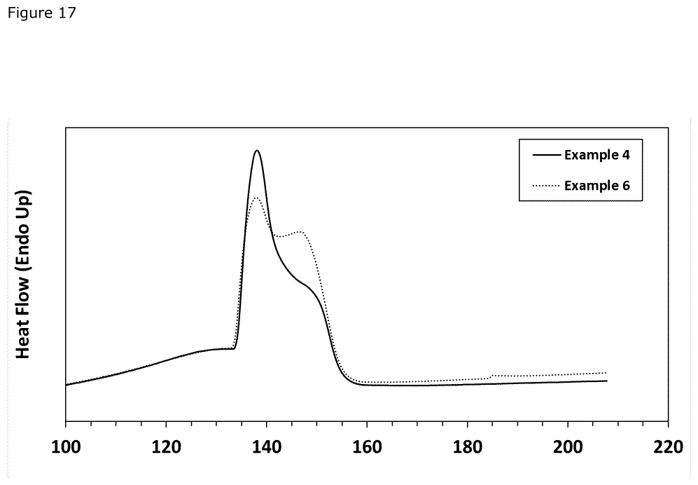

FIG. 18 shows second melt DSC traces for annealed Example 7;

FIG. 19 shows second melt DSC traces with 150° C. annealing for Comparative Example 2 and Example 7;

FIG. 20 shows second melt DSC traces for Comparative Example 2 and Example 7 annealed at 140° C.;

FIG. 21 shows second melt DSC traces for annealed Example 8; and

FIG. 22 shows an illustration of the method of determination of onset and endset temperatures.

### DETAILED DESCRIPTION

### Composition:

A composition for producing expanded polypropylene (EPP) is provided. The composition comprises:
a first polypropylene comprising, as polymerized monomers, at least 90 wt. % propylene by weight of the first polypropylene,
an alpha nucleation inhibitor, and
a beta nucleation additive.

The first polypropylene is not particularly limited. Non-limiting examples of the first polypropylene are polypropylene homopolymers, isotactic polypropylene, or syndiotactic polypropylene. The first polypropylene may further comprise, as a polymerized monomer, up to 6 wt. % by weight of the first polypropylene, of one or more of ethylene, butene, pentene, hexene, or a combination thereof. The first polypropylene may be a random copolymer of propylene and ethylene, comprising up to 6 wt. % by weight of the first polypropylene, of ethylene.

The melt flow index of the first polypropylene may be from 0.1 to 500 g/10 minutes as measured according to ISO-1133-1. For example, the melt flow index of the first polypropylene may be at least 0.1, 0.2, 0.3, 0.4, 0.5, 0.6, 0.7, 0.7, 0.8, 0.9, 1, 2, 3, 4, 5, 6, 7, 8, 9, 10, 15, 20, 25, 30, 35, 40, 45, 50, 75, 100, 125, 150, 175, 200, 225, 250, 275, 300, 325, 350, 375, 400, or at least 475 g/10 minutes as measured according to ISO-1133-1. The melt flow index of the first polypropylene may be at most 500, 490, 480, 470, 460, 450, 440, 430, 420, 410, 400, 300, 390, 380, 370, 360, 350, 340, 330, 320, 310, 300, 290, 280, 270, 260, 250, 240, 230, 220, 210, 200, 175, 150, 125, 100, 75, 50, 25, 20, 15, or at most 10 475 g/10 minutes as measured according to ISO-1133-1.

The first polypropylene may have a molecular weight distribution, also referred to as polydispersity (Mw/Mn) of from 2.0 to 15.0. The molecular weight Mw of the first polypropylene may be from 10,000 g/mol to 1,000,000 g/mol or more, measured using gel permeation chromatography and polystyrene standards.

For example, the first polypropylene may have a weight average molecular weight of at least 10,000, 15,000, 20,000, 25,000, 30,000, 35,000, 40,000, 45,000, 50,000, 55,000, 60,000, 65,000, 70,000, 75,000, 80,000, 85,000, 90,000, 95,000, 100,000, 110,000, 115,000, 120,000, 125,000, 130,000, 135,000, 140,000, 145,000, 150,000, 160,000, 170,000, 180,000, 190,000, 200,000, 210,000, 220,000, 230,000, 240,000, 250,000, 260,000, 270,000, 280,000, 290,000, 300,000, 310,000, 320,000, 330,000, 340,000, 350,000, 360,000, 370,000, 380,000, 390,000, 400,000, 410,000, 420,000, 430,000, 440,000, 450,000, 455,000, 460,000, 470,000, 480,000, 490,000, 500,000, 510,000, 520,000, 530,000, 540,000, 560,000, 570,000, 580,000, 590,000, 600,000, 610,000, 620,000, 630,000, 640,000, 650,000, 660,000, 670,000, 680,000, 690,000, 700,000, 710,000, 720,000, 730,000, 740,000, 750,000, 760,000, 770,000, 780,000, 790,000, 800,000, 810,000, 820,000, 830,000, 840,000, 850,000, 860,000, 870,000, 880,000, 890,000, or at least 900,000 g/mol, measured using gel permeation chromatography and polystyrene standards. For example, the first polypropylene may have a weight average molecular weight of at most 2,000,000, 1,900,000, 1,800,000, 1,700,000, 1,600,000, 1,500,000, 1,400,000, 1,300,000, 1,200,000, 1,100,000, 1,000,000, 950,000, 900,000, 850,000, 800,000, 750,000, 700,000, 650,000, 600,000, 550,000, 500,000, 450,000, 400,000, 350,000, 300,000, 250,000, 200,000, 150,000, or at most 100,000 gm/mol, measured using gel permeation chromatography and polystyrene standards.

For example, the first polypropylene may have a number average molecular weight of at least 10,000, 15,000, 20,000, 25,000, 30,000, 35,000, 40,000, 45,000, 50,000, 55,000, 60,000, 65,000, 70,000, 75,000, 80,000, 85,000, 90,000, 95,000, 100,000, 110,000, 115,000, 120,000, 125,000, 130,000, 135,000, 140,000, 145,000, 150,000, 160,000, 170,000, 180,000, 190,000, 200,000, 210,000, 220,000, 230,000, 240,000, 250,000, 260,000, 270,000, 280,000, 290,000, 300,000, 310,000, 320,000, 330,000, 340,000, 350,000, 360,000, 370,000, 380,000, 390,000, 400,000, 410,000, 420,000, 430,000, 440,000, 450,000, 455,000, 460,000, 470,000, 480,000, 490,000, 500,000, 510,000, 520,000, 530,000, 540,000, 560,000, 570,000, 580,000, 590,000, 600,000, 610,000, 620,000, 630,000, 640,000, 650,000, 660,000, 670,000, 680,000, 690,000, 700,000, 710,000, 720,000, 730,000, 740,000, 750,000, 760,000, 770,000, 780,000, 790,000, 800,000, 810,000, 820,000, 830,000, 840,000, 850,000, 860,000, 870,000, 880,000, 890,000, or at least 900,000 g/mol, measured using gel permeation chromatography and polystyrene standards. For example, the first polypropylene may have a number average molecular weight of at most 2,000,000, 1,900,000, 1,800,000, 1,700,000, 1,600,000, 1,500,000, 1,400,000, 1,300,000, 1,200,000, 1,100,000, 1,000,000, 950,000, 900,000, 850,000, 800,000, 750,000, 700,000, 650,000, 600,000, 550,000, 500,000, 450,000, 400,000, 350,000, 300,000, 250,000, 200,000, 150,000, or at most 100,000 gm/mol, measured using gel permeation chromatography and polystyrene standards.

The polydispersity of the first polypropylene may be at least 2, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, 10.0, 10.2, 10.4, 10.6, 10.8, 11.0, 11.2, 11.4, 11.6, 11.8, 12.0, 12.2, 12.4, 12.6, 12.8, 13.0, 13.2, 13.4, 13.6, 13.8, or at least 14.0. The polydispersity of the first polypropylene may be at most 15.0, 14.8, 14.6, 14.4, 14.2, 14.0, 13.8, 13.6, 13.4, 13.2, 13.0, 12.8, 12.6, 12.4, 12.2, 12.0, 11.8, 11.6, 11.4, 11.2, 11.0, 10.8, 10.6, 10.4, 10.2, 10.0, 9.8, 9.6, 9.4, 9.2, 9.0, 8.8, 8.6, 8.4, 8.2, 8.0, 7.8, 7.6, 7.4, 7.2, 7.0, 6.8, 6.6, 6.4, 6.2, 6.0, 5.8, 5.6, 5.4, 5.2, 5.0, 4.8, 4.6, 4.4, 4.2, 4.0, 3.8, 3.6, 3.4, 3.2, or at most 3.0.

The first polypropylene can for example be produced with a metallocene catalyst or with a Ziegler-Natta catalyst. The first polypropylene may be produced in the gas-phase, in suspension, in solution or in the melt. The molecular weight distribution may be reduced by thermal or chemical post-reactor treatment, for example by degradation with a peroxide (“visbreaking”). Molecular weights may be determined by gel permeation chromatography (GPC) as described in the examples.

The first polypropylene used in the present invention can either be homopolymer or random copolymer of propylene with one or more comonomers. The comonomers can be ethylene or a C4-C28 α-olefin, such as for example butene-1, pentene-1, hexene-1, octene-1, or 4-methyl-pentene-1. According to an embodiment, the random copolymer is a copolymer of propylene and ethylene. The random copolymers of the first polypropylene of the present invention may comprise at least 0.1 wt %, or at least 0.2 wt % or at least 0.5 wt % of comonomer by weight of the first polypropylene. They may comprise at most 6.0 wt %, or at most 5.0 wt % or at most 4.0 wt % of comonomer by weight of the first polypropylene.

The alpha nucleation inhibitor may comprise potassium stearate.

Non-limiting examples of the beta nucleation additive are gamma-crystalline form of quinacridone dye; aluminum salt of 6-quinazirin sulfonic acid; disodium salt o-phthalic acid; isophthalic acid or derivative thereof; terephthalic acid or derivative thereof; N′,N′-dicyclohexyl-2,6-naphthalene dicarboxamide; a blend of organic dibasic acid with oxide, hydroxide, or acid of Group II metal; or a combination thereof.

The composition of may further comprise up to 5 wt. % by weight of the composition of a second polypropylene. The second polypropylene is different from the first polypropylene and comprises, as polymerized monomer, at least 99 wt. % propylene by weight of the second polypropylene. Importantly, this second polypropylene is a high crystallinity polypropylene and comprises at least 50 wt. % crystallinity by weight of the second polypropylene. The second polypropylene may comprise at least 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 48, 85, 86, 87, 88, 89 or at least 90 wt. % crystallinity by weight of the second polypropylene. The wt. % crystallinity is measured as described in he Examples section. The second polypropylene is not otherwise particularly limited. Non-limiting examples of the second polypropylene are polypropylene homopolymers, isotactic polypropylene, or syndiotactic polypropylene. The second polypropylene may further comprise, as a polymerized monomer, up to 1 wt. % by weight of the second polypropylene, of one or more of ethylene, butene, pentene, hexene, or a combination thereof. The second polypropylene may be a random copolymer of propylene and ethylene, comprising up to 1 wt. % by weight of the second polypropylene, of ethylene. The melt flow index of the second polypropylene may be from 0.1 to 500 g/10 minutes as measured according to ISO-1133-1. For example, the melt flow index of the second polypropylene may be at least 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45, 50, 100, 125, 150, 175, 200, 225, 250, 275, 300, 325, 350, 375, 400, or at least 475 g/10 minutes as measured according to ISO-1133-1. The melt flow index of the second polypropylene may be at most 500, 490, 480, 470, 460, 450, 440, 430, 420, 410, 400, 300, 390, 380, 370, 360, 350, 340, 330, 320, 310, 300, 290, 280, 270, 260, 250, 240, 230, 220, 210, 200, 175, 150, 125, 100, 75, 50, 25, 20, 15, or at most 10 g/10 minutes as measured according to ISO-1133-1.

The second polypropylene may have a molecular weight distribution (Mw/Mn) of from 2.0 to 15.0. The molecular weight Mw of the second polypropylene may be from 10,000 g/mol to 1,000,000 g/mol or more, measured using gel permeation chromatography and polystyrene standards. For example, the second polypropylene may have a weight average molecular weight of at least 10,000, 15,000, 20,000, 25,000, 30,000, 35,000, 40,000, 45,000, 50,000, 55,000, 60,000, 65,000, 70,000, 75,000, 80,000, 85,000, 90,000, 95,000, 100,000, 110,000, 115,000, 120,000, 125,000, 130,000, 135,000, 140,000, 145,000, 150,000, 160,000, 170,000, 180,000, 190,000, 200,000, 210,000, 220,000, 230,000, 240,000, 250,000, 260,000, 270,000, 280,000, 290,000, 300,000, 310,000, 320,000, 330,000, 340,000, 350,000, 360,000, 370,000, 380,000, 390,000, 400,000, 410,000, 420,000, 430,000, 440,000, 450,000, 455,000, 460,000, 470,000, 480,000, 490,000, 500,000, 510,000, 520,000, 530,000, 540,000, 560,000, 570,000, 580,000, 590,000, 600,000, 610,000, 620,000, 630,000, 640,000, 650,000, 660,000, 670,000, 680,000, 690,000, 700,000, 710,000, 720,000, 730,000, 740,000, 750,000, 760,000, 770,000, 780,000, 790,000, 800,000, 810,000, 820,000, 830,000, 840,000, 850,000, 860,000, 870,000, 880,000, 890,000, or at least 900,000 g/mol, measured using gel permeation chromatography and polystyrene standards. For example, the second polypropylene may have a weight average molecular weight of at most 2,000,000, 1,900,000, 1,800,000, 1,700,000, 1,600,000, 1,500,000, 1,400,000, 1,300,000, 1,200,000, 1,100,000, 1,000,000, 950,000, 900,000, 850,000, 800,000, 750,000, 700,000, 650,000, 600,000, 550,000, 500,000, 450,000, 400,000, 350,000, 300,000, 250,000, 200,000, 150,000, or at most 100,000 gm/mol, measured using gel permeation chromatography and polystyrene standards.

For example, the second polypropylene may have a number average molecular weight of at least 10,000, 15,000, 20,000, 25,000, 30,000, 35,000, 40,000, 45,000, 50,000, 55,000, 60,000, 65,000, 70,000, 75,000, 80,000, 85,000, 90,000, 95,000, 100,000, 110,000, 115,000, 120,000, 125,000, 130,000, 135,000, 140,000, 145,000, 150,000, 160,000, 170,000, 180,000, 190,000, 200,000, 210,000, 220,000, 230,000, 240,000, 250,000, 260,000, 270,000, 280,000, 290,000, 300,000, 310,000, 320,000, 330,000, 340,000, 350,000, 360,000, 370,000, 380,000, 390,000, 400,000, 410,000, 420,000, 430,000, 440,000, 450,000, 455,000, 460,000, 470,000, 480,000, 490,000, 500,000, 510,000, 520,000, 530,000, 540,000, 560,000, 570,000, 580,000, 590,000, 600,000, 610,000, 620,000, 630,000, 640,000, 650,000, 660,000, 670,000, 680,000, 690,000, 700,000, 710,000, 720,000, 730,000, 740,000, 750,000, 760,000, 770,000, 780,000, 790,000, 800,000, 810,000, 820,000, 830,000, 840,000, 850,000, 860,000, 870,000, 880,000, 890,000, or at least 900,000 g/mol, measured using gel permeation chromatography and polystyrene standards. For example, the second polypropylene may have a number average molecular weight of at most 2,000,000, 1,900,000, 1,800,000, 1,700,000, 1,600,000, 1,500,000, 1,400,000, 1,300,000, 1,200,000, 1,100,000, 1,000,000, 950,000, 900,000, 850,000, 800,000, 750,000, 700,000, 650,000, 600,000, 550,000, 500,000, 450,000, 400,000, 350,000, 300,000, 250,000, 200,000, 150,000, or at most 100,000 gm/mol, measured using gel permeation chromatography and polystyrene standards.

The polydispersity of the second polypropylene may be at least 2, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, 10.0, 10.2, 10.4, 10.6, 10.8, 11.0, 11.2, 11.4, 11.6, 11.8, 12.0, 12.2, 12.4, 12.6, 12.8, 13.0, 13.2, 13.4, 13.6, 13.8, or at least 14.0. The polydispersity of the second polypropylene may be at most 15.0, 14.8, 14.6, 14.4, 14.2, 14.0, 13.8, 13.6, 13.4, 13.2, 13.0, 12.8, 12.6, 12.4, 12.2, 12.0, 11.8, 11.6, 11.4, 11.2, 11.0, 10.8, 10.6, 10.4, 10.2, 10.0, 9.8, 9.6, 9.4, 9.2, 9.0, 8.8, 8.6, 8.4, 8.2, 8.0, 7.8, 7.6, 7.4, 7.2, 7.0, 6.8, 6.6, 6.4, 6.2, 6.0, 5.8, 5.6, 5.4, 5.2, 5.0, 4.8, 4.6, 4.4, 4.2, 4.0, 3.8, 3.6, 3.4, 3.2, or at most 3.0.

The second polypropylene can for example be produced with a metallocene catalyst or with a Ziegler-Natta catalyst. The second polypropylene may be produced in the gas-phase, in suspension, in solution, or in the melt. The molecular weight distribution of the second polypropylene may be reduced by thermal or chemical post-reactor treatment, for example by degradation with a peroxide (“visbreaking”). Molecular weights may be determined by gel permeation chromatography (GPC) as described in the examples.

The second polypropylene used in the present invention can either be homopolymer or random copolymers of propylene with one or more comonomers. The comonomers can be ethylene or a C4-C28 α-olefin, such as for example butene-1, pentene-1, hexene-1, octene-1 or 4-methyl-pentene-1. According to an embodiment, the random copolymer is a copolymer of propylene and ethylene. The random copolymers of the second polypropylene of the present invention may comprise at least 0.1 wt %, or at least 0.2 wt % or at least 0.5 wt % of comonomer by weight of the second polypropylene. They comprise at most 1.0 wt %, or at most 0.3 wt % or at most 0.5 wt % of comonomer by weight of the second polypropylene.

After annealing at an annealing temperature Ta for an annealing time ta, the composition has a first melting peak T1 and a second melting peak T2, as measured by differential scanning calorimetry at a heating rate of 20° C. per minute. According to certain embodiments, the annealing temperature Ta may be from 90° C. to 200° C. According to certain embodiments, the annealing temperature may be from 100° C. to 180° C. or from 120° C. to 160° C. According to some embodiments, the annealing temperature Ta may be at least 90° C., at least 95, 100, 105, 110, 115, 120, 125, 130, 135, 140, 145, 150, 155, 160, 165, or at least 175° C. According to certain embodiments the annealing temperature may be at most 200° C. or most 195, 190, 185, 180, 175, 170, 165, 160, 155, 150, 145, 140, 135, 130, or at most 125° C. According to certain embodiments, the first melting peak T1 may be from 110° C. to 165° C. According to certain embodiments, the first melting peak T1 may be from 135° C. to 165° C. or from 140° C. to 155° C. According to certain embodiments, the second melting peak T2 is from 150° C. to 180° C. According to some embodiments, the second melting peak is from 155° C. to 175° C. or from 160° C. to 170° C. According to an embodiment, the composition may have a third melting peak T3. The third melting peak T3 may be from 160° C. to 180° C., or from 165° C. to 175° C. The melting peaks are measured as described in the Examples.

The composition as a whole, may have a crystallinity of at least 25 wt. % based on the total weight of the first polypropylene, measured as described in the Examples.

The composition may further comprise a blowing agent. Non-limiting examples of suitable blowing agents are gasses such as CO₂, nitrogen, small alkanes such as n-butane or n-pentane, and combinations thereof.

The composition may be in the form of a masterbatch. A masterbatch is a concentrated composition used to accurately portion additives into the polypropylene composition. The carrier for the masterbatch may be the first polypropylene or the second polypropylene or another polymer or polypropylene. In the masterbatch, the alpha nucleation inhibitor and the beta nucleation additive together comprise from 0.1 to 80 wt. % based on the total weight of the masterbatch composition.

### Methods:

A method of preparing a foamable polypropylene composition is provided. The method comprises the steps of:
a) compounding a first polypropylene comprising, as polymerized monomers, at least 90 wt. % propylene by weight of the first polypropylene with an alpha nucleation inhibitor to form a polypropylene blend;
b) compounding the polypropylene blend with a blowing agent to form a pre-annealed polypropylene composition; and
c) annealing the pre-annealed polypropylene composition at an annealing temperature Ta for an annealing time ta to form the foamable polypropylene composition, wherein the foamable polypropylene composition has a first melting peak T1 and a second melting peak T2 as measured by differential scanning calorimetry at a heating rate of 20° C. per minute.

According to an embodiment, the pre-annealed polypropylene may have a third melting peak T3.

According to another embodiment, the step a) of the method may further comprise compounding a beta nucleation additive with the first polypropylene and the alpha nucleation inhibitor to form the polypropylene blend. According to an embodiment, at least one of the beta nucleation additive and the alpha nucleation inhibitor may be in the form of a masterbatch. According to an embodiment, step a) and step b) may be performed in a single compounding operation.

According to another embodiment the step b) further may comprise pelletizing the pre-annealed polypropylene composition.

A method of preparing a foamed polypropylene composition is provided. The method comprising heating the foamable polypropylene composition to a foaming temperature that is higher than T1 and lower than T2. This heating step may be done at a pressure below 1 atm. For example, the pressure may be 0.95 atm, or 0.90, 0.85, 0.80, 0.75, 0.70, 0.65, 0.60, 0.55, or 0.50 atm or less.

### Examples

### Methods:

Differential Scanning calorimetry (DSC): The DSC experiments were performed on a Discovery 250 instrument manufactured by TA Instruments on what 5 to 7 milligram samples. The samples were run under nitrogen and the instrument was calibrated using an indium standard as described in the Examples.

For nonisothermal testing, ASTM 3418-21 was followed. Specifically, the sample was equilibrated at 50° C. for one minute, ramped at 10° C./minute to 210° C., held at 210° C. for five minutes, cooled at −10° C./minute to 50° C., held at 50° C. for one minute, reheated to 190° C. at 10° C./minute, then cooled to 50° C. to end the test. This method provides crystallization data such as crystallization temperature and enthalpy during the cooling trace. The second heating trace provides melting temperature and enthalpy data.

For the DSC testing with annealing at different temperatures, an internal procedure was used. The details of the procedure are provided below.

Compounding: In preparation for compounding, reactor polypropylene powder was blended with additives before being introduced to the extruder. Blending was performed on a high intensity mixer for one minute. The high intensity mixer was a Prodex Corporation Model 18JSS.

After the powder was blended, it was added to a 1¼″ single screw extruder. The extruder was an American Kuhne, Model AK 125 24 AC 5HP ULT. The extruder temperature setting was 410° F./420° F./420° F./430° F./430° F./430° F. for Zone 1 (feed)/Zone 2/Zone 3/Clamp/Die 1/Die 2. The extruder was equipped with a 100 mesh screenpack. After the die, the strands were passed through a water bath kept at room temperature and pelletized.

Melt Flow Index (MFI): The MFI measurements were conducted according to ASTM-D1238-20. The testing equipment was a Tinius Olsen Plastometer, either Model MP600 or MP1200. Each test consumes approximately 7 grams of pellets. All MFI testing was at 230° C. per the ASTM standard, using an orifice with a 2.095 mm diameter and a length of 8.00 mm. The melt temperature was 230° C.

Mw, Mn: Weight and number average molecular weight (Mw, Mn) were determined by gel permeation. The GPC instrument used was a Polymer Char GPC-IR equipped with three columns. The first two columns were Shodex AT-80 M/S (Part No. 34200) linear columns. The third column was a Waters Ultrastyragel High Temperature Linear (Part No. 35554) column. 16 mg samples were placed in a 10 ml vial, to which the GPC-IR auto sampler automatically added 8 ml of the trichlorobenzene (TCB) solvent. The samples were run at 135-145° C. Analysis of the elutriate were via an infrared detector. Polystyrene samples were used.

Percent crystallinity: The percent crystallinity was determined by measuring the heat of fusion of each sample, then dividing that result by the heat of fusion for a 100% crystalline sample for polypropylene. The value for a 100% crystalline polypropylene used herein is 207 J/g. The heat of fusion for each sample is determined using nonisothermal testing under ASTM 3418-21 or under the heating ramps after annealing.

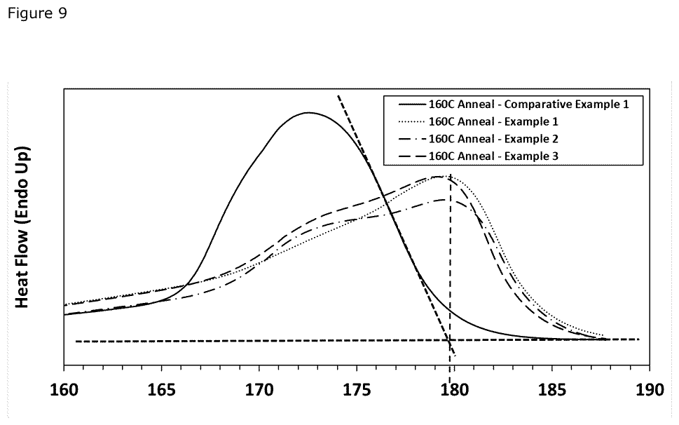

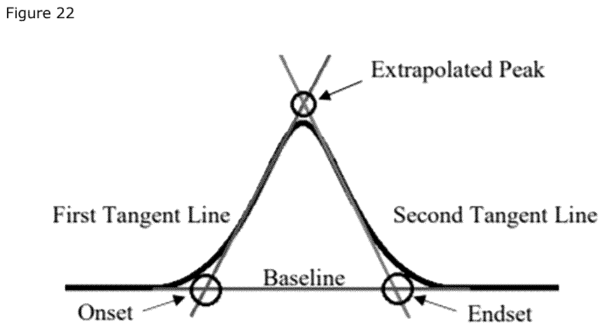

Endset melting point and onset melting point: Onset and endset melting point determination were determined in nonisothermal heating ramps. They were determined by extending the baseline and the tangent line from the melting curve, with those temperatures defined by where the two lines intersect. FIG. 9 illustrates an example of the endset temperature. FIG. 22 also provides an illustration of determining the onset and endset melting points.

All percents are weight percents unless stated otherwise.

All parts, e.g. parts per million (ppm), are parts weight unless stated otherwise.

### Examples 1-3, Comparative Example 1: Effect of beta nucleation additive and alpha nucleation inhibitor on melting behavior of high crystallinity polypropylene

A polypropylene homopolymer (TotalEnergies 3270) having a melt flow index MFI of 2 gm/10 minutes as measured by ASTM D1238-20 was used as the base polymer to prepare the following four compositions shown in Table 1 below.

TABLE 1
Compositions for Comparative Example 1 and Examples 1-4

| | | | | Example 3 |
|---|---|---|---|---|
| | | | | Effect of |
| | | Example 1 | Example 2 | adding beta |
| | | Effect of | Effect of | nucleation |
| | | adding | adding | additive |
| | | beta | alpha | and alpha |
| | Comparative | nucleation | nucleation | nucleation |
| | Example 1 | additive | inhibitor | inhibitor |
| Irganox ® 1010 | 1000 ppm | 1000 ppm | 1000 ppm | 1000 ppm |
| (antioxidant) | | | | |
| Irgafos ® 168 | 1000 ppm | 1000 ppm | 1000 ppm | 1000 ppm |
| (antioxidant) | | | | |
| Calcium | 2000 ppm | 2000 ppm | — | — |
| stearate (acid | | | | |
| neutralizer) | | | | |
| NJ Star NU-100 | — | 2000 ppm | — | 2000 ppm |
| (beta nucleation | | | | |
| additive) | | | | |
| Potassium | — | — | 2000 ppm | 2000 ppm |
| stearate (alpha | | | | |
| nucleation | | | | |
| inhibitor) | | | | |
| TotalEnergies | balance | balance | balance | balance |
| 3270 PP | | | | |

Irganox® 1010 (BASF) is a tradename for pentaerythritol tetrakis [3-[3,5-di-tert-butyl-4-hydroxyphenyl]propionate. The Chemical Abstracts Service Number (CAS Number) is 6683-19-8. Irgafos® 168 (BASF) is a tradename for tris(2,4-ditert-butylphenyl)phosphite and its CAS Number is 31570 Apr. 4. Calcium stearate CAS number is 1592-23-0. Potassium stearate CAS Number is 593-29-3. NJ Star NU-100 (New Japan Chemical Co.) is N,N-dicyclohexyl-2,6-naphthalene dicarboxamide. Its CAS Number is 153250-52-3.

DSC testing was performed as follows to determine the effect of the beta nucleation additive and the alpha nucleation inhibitor on the melting behavior of the polypropylene, both alone, and in combination.
1. Ramp 20° C./min to 210° C. Hold for 5 minutes.
2. Ramp −20° C./min to 50° C. Hold for 1 minutes.
3. Ramp 20° C./min to 120° C. Hold for 15 minutes. This is the 120° C. anneal.
4. Ramp −20° C./min to 23° C. Hold for 1 minute.
5. Ramp 20° C./min to 190° C. Hold for 1 minute.
6. Ramp −20° C./min to 23° C. Hold for 1 minute.
7. Ramp 20° C./min to 130° C. Hold for 15 minutes. This is the 130° C. anneal.
8. Ramp −20° C./min to 23° C. Hold for 1 minute.
9. Ramp 20° C./min to 190° C. Hold for 1 minute.
10. Ramp −20° C./min to 23° C. Hold for 1 minute.
11. Ramp 20° C./min to 140° C. Hold for 15 minutes. This is the 140° C. anneal.
12. Ramp −20° C./min to 23° C. Hold for 1 minute.
13. Ramp 20° C./min to 190° C. Hold for 1 minute.
14. Ramp −20° C./min to 23° C. Hold for 1 minute.
15. Ramp 20° C./min to 150° C. Hold for 15 minutes. This is the 150° C. anneal.
16. Ramp −20° C./min to 23° C. Hold for 1 minute.
17. Ramp 20° C./min to 190° C. Hold for 1 minute.
18. Ramp −20° C./min to 23° C. Hold for 1 minute.
19. Ramp 20° C./min to 160° C. Hold for 15 minutes. This is the 160° C. anneal.
20. Ramp −20° C./min to 23° C. Hold for 1 minute.
21. Ramp 20° C./min to 190° C. Hold for 1 minute.
22. Cool to room temperature and end test.

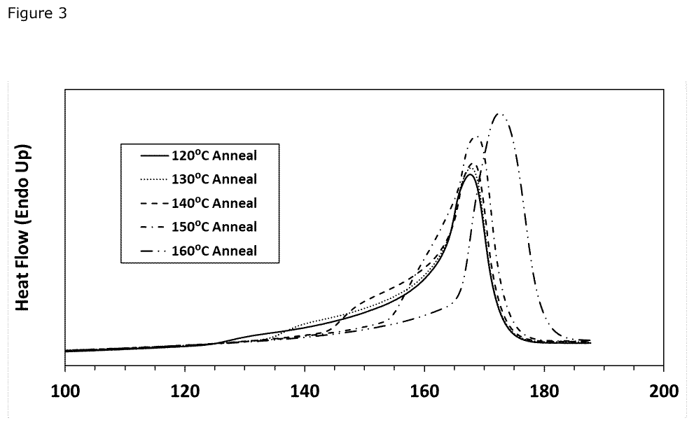

The DSC results for Comparative Example 1 as shown in FIG. 3, show how the baseline polymer, a high crystallinity polypropylene resin, responded to the annealing steps at each holding temperature. None of the annealing temperatures yielded the desirable double peak behavior that is useful to produce the polypropylene foams. Instead, the result was a shifting of the lower melting portion of the endotherm to hotter temperatures. This formed a more pronounced shoulder in the left-hand portions of the DSC trace, which progressively pushed into the main body of the peak. This behavior changed with the 160° C. anneal which shifted the peak melting temperature higher while at the same time kept a unimodal shape. This shows that annealing of the high crystallinity polypropylene does not yield the double peak behavior that is typical in random copolymer polypropylene used for expanded polypropylene grades. At all of the annealing temperatures it appeared that negligible unmelted species are present at 190° C. The higher melting peak development can be quantified with respect to the increase of the number of higher melting species to successively hotter temperatures. The quantification can be defined by the ‘endset melting temperature (Tes)’, defined similarly to the onset melting temperature. The endset melting temperature is determined by taking the meeting temperature between the slope off of the melting curve and the baseline. The shift in peak melting temperature is shown in Table 2. As shown in Table 2, annealing temperatures from 120° C. to 150° C. only shifted the peak about 1° C. in total. However, the annealing temperature of 160° C. in produced nearly a 4° C. increase in melting temperature.

TABLE 2
Peak melting temperature and endset melting temperature for
Comparative Example 1 at various annealing temperatures.

| Annealing | Peak Melting | Endset Melting |
|---|---|---|
| temperature | Temperature | Temperature |
| (° C.) | (° C.) | (° C.) |
| 120 | 167.58 | 172.71 |
| 130 | 167.75 | 172.85 |
| 140 | 168.13 | 173.22 |
| 150 | 168.58 | 174.03 |
| 160 | 172.50 | 179.96 |

Table 1 shows also that a similar change was seen in the endset melting temperature. The annealing temperatures from 120° C. to 150° C. caused the endset temperature (Tes) to shift just over 1° C. higher. The shift was nearly 6° C. when the annealing temperature is raised from 150° C. to 160° C.

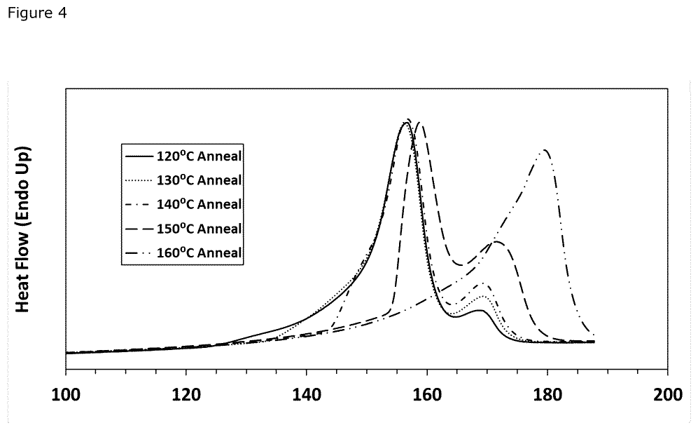

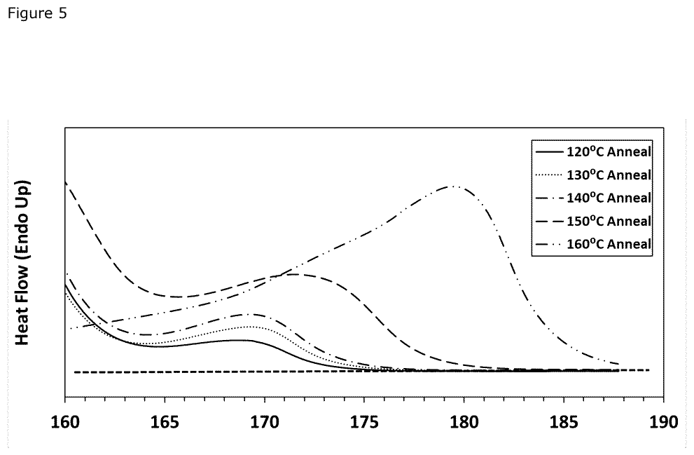

Introducing 2000 ppm beta nucleation additive in Example 1 produced bimodal melting endotherms when the sample was annealed at temperatures of 120° C. through 150° C., as shown in FIG. 4. Furthermore, these data illustrate that the size and shape of the two melting peaks and their shape changed depending on the annealing temperature. A higher annealing temperature resulted in the second, higher melting peak also being higher. Additionally, the higher annealing temperatures also resulted in a larger area under the second melting peak, signifying a larger number of high melting point crystals. The second higher melting peak itself also moved to higher melting points. Clearly all of these effects are due to the presence of the beta nucleation additive. FIG. 5 is the same DSC data as FIG. 4, but is plotted over a smaller temperature range, in order to show more clearly the effect of the beta nucleation additive on the second melting peak at the various annealing temperatures. These higher melting species are important in EPP (expanded polypropylene) processing. Without wishing to be bound to any particular theory, these high melting crystallites may create physical crosslinks and thereby may provide a framework for maintaining the foam structure even at higher temperatures.

The attributes of the melting peaks in the polymer that includes the beta nucleation additive (Example 1) are listed in Table 2. The two peaks (lower melting and higher melting) had a difference of from about 12° C. to about nearly 13° C. This spread is narrower than the 20° C. typical for random copolymers of propylene and ethylene but is still substantial and importantly, is not present at all in the same polymer annealed in the same way without the beta nucleation additive, as shown above in comparative Example 1.

TABLE 3
Peak melting temperatures and endset melting temperature for
Example 1 (TotalEnergies 3270 and beta nucleation additive).

| | Lower Peak | Higher Peak | Tm Delta | Endset |
|---|---|---|---|---|
| Annealing | Melting | Melting | (Tm2 − | Melting |
| Temperature | Temperature | Temperature | Tm1) | Temperature |
| (° C.) | (° C.) | (° C.) | (° C.) | (° C.) |
| 120 | 156.65 | 168.41 | 11.76 | 173.48 |
| 130 | 156.26 | 169.16 | 12.90 | 173.76 |
| 140 | 156.61 | 169.24 | 12.63 | 174.32 |
| 150 | 158.81 | 171.61 | 12.80 | 178.68 |
| 160 | N/A | 179.45 | N/A | 185.06 |

The endset melting temperatures for comparative Example 1 and Example 1 were also determined to evaluate the effect of the addition of the beta nucleation additive. Surprisingly, adding the beta nucleation additive was found to promote the formation of higher melting species, rather than merely to help generate lower melting species within the typical range of the beta crystallites. This effect is important for many applications requiring high temperature resistance, including the steam chest portion of the EPP process. Table 3 lists the data that supports this. As can be seen in Table 3, the beta nucleation additive is more effective at generating higher melting species at the hotter annealing temperatures of 150° C. and 160° C.

TABLE 4
Endset melting temperature comparison between
Comparative Example and Example 1.

| | Comparative Example 1 | Example 1 |
|---|---|---|
| Annealing | Endset Melting | Endset Melting |
| Temperature | Temperature | Temperature |
| (° C.) | (° C.) | (° C.) |
| 120 | 172.71 | 173.48 |
| 130 | 172.85 | 173.76 |
| 140 | 173.22 | 174.32 |
| 150 | 174.03 | 178.68 |
| 160 | 179.96 | 185.06 |

Next, in Example 2, the effect of adding an alpha nucleation inhibitor on the response to various annealing temperatures was determined. The DSC curves for Example 2 compared to Comparative Example 1 are shown in FIG. 5. As can be seen in FIG. 5, annealing at 120° C. provided a unimodal profile. However, surprisingly, annealing at temperatures of 130° C., 140° C. and 150° C. created bimodal melting endotherm peaks. As the annealing temperature progressed upwards, the second melting peak became the peak temperature shifted to higher temperatures. Ultimately, as in Example 1, where a beta nucleation additive was added, at 160° C. annealing temperature the peak became unimodal. However, it had a very strong lower temperature shoulder.

Similarly to the addition of the beta nucleation additive in Example 1, when the alpha nucleation inhibitor was added in Example 2, at 160° C. annealing temperature, more higher melting species were generated compared to the Comparative Example 1.

Attributes of these melting peaks shown in FIG. 5 are listed in Table 4. The two peaks have a difference of about just over 13° C. This spread is narrower than the 20° C. typical for random copolymer polypropylene but is still substantial and importantly, is not seen in the Comparative Example that does not include the alpha nucleation inhibitor.

TABLE 5
Peak melting temperatures and endset melting temperature
for Example 2 including the alpha nucleation inhibitor
(Alpha nucleation inhibited TotalEnergies 3270).

| | Lower Peak | Higher Peak | Tm Delta | Endset |
|---|---|---|---|---|
| Annealing | Melting | Melting | (Tm2 − | Melting |
| Temperature | Temperature | Temperature | Tm1) | Temperature |
| (° C.) | (° C.) | (° C.) | (° C.) | (° C.) |
| 120 | N/A | 167.47 | N/A | 173.48 |
| 130 | 155.16 | 168.39 | 13.23 | 174.88 |
| 140 | 155.72 | 169.09 | 13.37 | 175.31 |
| 150 | 157.47 | 170.81 | 13.34 | 179.80 |
| 160 | N/A | 179.42 | N/A | 185.18 |

As seen in the DSC traces in FIG. 5 and in Table 4, adding an alpha nucleation inhibitor resulted in the formation of more higher melting species. This result is unexpected, since the alpha crystallites have a higher melting point than the beta crystallites and is important for many applications requiring high temperature resistance, including especially the steam chest portion of the EPP process.

Table 6 lists the data showing this effect. Table 6 shows that the effect of more higher melting species in the presence of the aspect of the alpha nucleation inhibitor being greater at the hotter annealing temperatures of 150° C. and 160° C.

TABLE 6
Endset melting temperature comparison between
Comparative Example 1 and Example 2.

| | Comparative Example 1 | Example 2 |
|---|---|---|
| Annealing | Endset Melting | Endset Melting |
| Temperature | Temperature | Temperature |
| (° C.) | (° C.) | (° C.) |
| 120 | 172.71 | 173.48 |
| 130 | 172.85 | 174.88 |
| 140 | 173.22 | 175.31 |
| 150 | 174.03 | 179.80 |
| 160 | 179.96 | 185.18 |

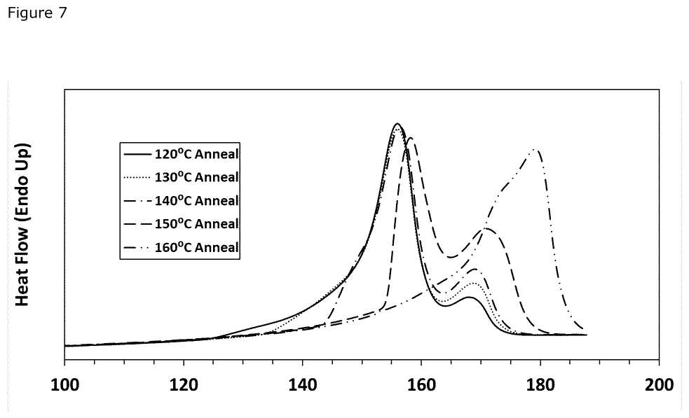

Example 3 includes both the beta nucleation additive and the alpha nucleation inhibitor. The effect of the alpha nucleation inhibitor together with the beta nucleation additive on melting behaviour is shown in FIG. 7. As shown in the figure, these two additives can be used together to produce the desired bimodal melting endotherm melting shape. The attributes of these melting peaks are listed in Table 7. The two peaks have a difference of more than 11.5° C. to just over 12.5° C. This spread is narrower than the 20° C. typical for random copolymer polypropylene, but is still substantial and not seen in high crystallinity polypropylene homopolymer.

TABLE 7
Melting behavior of Example 3.

| | Lower Peak | Higher Peak | Tm Delta | Endset |
|---|---|---|---|---|
| Annealing | Melting | Melting | (Tm2 − | Melting |
| Temperature | Temperature | Temperature | Tm1) | Temperature |
| (° C.) | (° C.) | (° C.) | (° C.) | (° C.) |
| 120 | 155.93 | 167.82 | 11.89 | 173.28 |
| 130 | 155.92 | 168.57 | 12.65 | 173.94 |
| 140 | 156.32 | 168.88 | 12.56 | 174.39 |
| 150 | 158.17 | 170.81 | 12.64 | 178.24 |
| 160 | N/A | 179.08 | N/A | 184.14 |

The effect on the endset temperature at these various annealing temperatures of the beta nucleation additive used together with the alpha nucleation inhibitor is discussed as follows.

Surprisingly, adding an alpha nucleation inhibitor together with a beta nucleation additive encouraged the formation of higher melting species. This result was not expected, since the alpha form of crystallites is higher melting than the beta crystallites. The implications are important for many applications requiring high temperature resistance, including the steam chest portion of the EPP process. Table 8 lists the data that supports this. As seen in Table 8, the enhancing aspect of the alpha nucleation inhibitor greater at the hotter annealing temperatures of 150° C. and 160° C.

TABLE 8
Endset melting temperature comparison between
Comparative Example 1 and Example 3.

| | Comparative Example 1 | Example 3 |
|---|---|---|
| Annealing | Endset Melting | Endset Melting |
| Temperature | Temperature | Temperature |
| (° C.) | (° C.) | (° C.) |
| 120 | 172.71 | 173.28 |
| 130 | 172.85 | 173.94 |
| 140 | 173.22 | 174.39 |
| 150 | 174.03 | 178.24 |
| 160 | 179.96 | 184.14 |

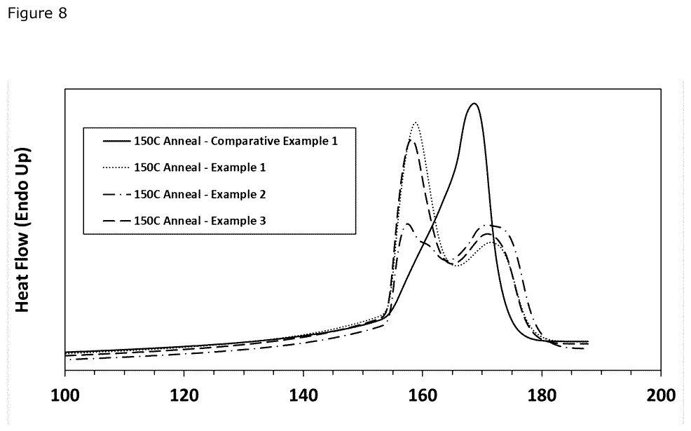

A visual assessment of annealing of each Comparative Example 1, and Examples 1-3 at 150° C. are shown in FIG. 8. Interestingly, the peak intensity of Example 3 had a peak height for both the first and second peak between the Example 1 having only the beta nucleation additive, and the Example 2 having only the alpha nucleation inhibitor. Therefore, the combination of beta nucleation additive and alpha nucleation inhibitor is a surprisingly act together to provide the desired duel melting peak behavior. Combining the beta nucleation additive and the alpha nucleation inhibitor can be used to adjust crystallization behavior to an optimal level for the industry.

A second finding is that the alpha nucleation inhibitor at the annealing temperature of 150° C. provided a more balanced peak size between the first and second melting peaks. This response strength versus the beta nucleation additive underscores that the crystallization kinetics may be different between these two additives and gives the practitioner two separate tools for modifying and optimizing performance for a given annealing process. What is optimal for a process like expanded polypropylene EPP might be completely different in annealing slit film yarns, for example.

The effect of the alpha nucleation inhibitor, the beta nucleation additive and combinations of these two in forming higher melting crystallites is illustrated in FIG. 9. The endset melting temperature for the Comparative Example 1 (no beta nucleation additive and no alpha nucleation inhibitor) baseline TotalEnergies 3270 is 179.96° C. Meanwhile, the peaks of the higher melting endotherms for Example 1-3 are 179.08° C. to 179.45° C. Clearly, these additives together yielded a substantial number of crystalline species that melt at above 180° C. as well as a crystalline species that melt higher than 185° C.

It is known in the art that crystallites can serve as physical crosslinks. Accordingly, at elevated temperatures, these formulations of Example 1-3 can better resist deformation, which would produce higher Vicat softening points and higher heat deflection temperatures. It would also make these formulations more viscous than the baseline Comparative Example 1 formulation because the residual crystallites would greatly increase the melt's resistance to flow. This attribute desirable in foaming processes such as EPP, because high melting species are needed to help maintain structural integrity in the steam chest forming process. The high melting crystallites are expected to be useful in other processes where the polymer is softened for further forming, such as thermoforming and injection stretch blow molding of preforms.

### Comparative Example 2 and Examples 4-8. Effect of Addition of High Crystallinity PP on the Melting Behaviour of Ziegler Natta Catalyzed Random Copolymer (Propylene/Ethylene Copolymer) Together with the Beta Nucleation Additive and the Alpha Nucleation Inhibitor

### Testing Materials and Conditions

TotalEnergies 6575 was used as the base polymer powder in making the six compounds listed below in Table 9. This polymer is an 8 MFR Ziegler-Natta polypropylene. Its melting temperature is about 145° C. This MFR and melting temperature is typical for RCPs used in EPP applications. All six compounds contained 1000 ppm of Irganox® 1010 and 1000 ppm of Irgafos® 168 as antioxidants. The compound numbers and descriptions follow below in Table 9.

TABLE 9
Comparative Example 2, Examples 4-8 compositions.

| | Comparative | Example | Example | Example | Example | Example |
|---|---|---|---|---|---|---|
| | Example 2 | 4 | 5 | 6 | 7 | 8 |
| Irganox | 1000 ppm | 1000 ppm | 1000 ppm | 1000 ppm | 1000 ppm | 1000 ppm |
| 1010 | | | | | | |
| (antioxidant) | | | | | | |
| Irgafos 168 | 1000 ppm | 1000 ppm | 1000 ppm | 1000 ppm | 1000 ppm | 1000 ppm |
| (antioxidant) | | | | | | |
| Calcium | 2000 ppm | 2000 ppm | 2000 ppm | 2000 ppm | 2000 ppm | 2000 ppm |
| stearate | | | | | | |
| (acid | | | | | | |
| neutralizer) | | | | | | |
| NJ Star NU- | — | 2000 ppm | — | 2000 ppm | — | — |
| 100 (beta | | | | | | |
| nucleation | | | | | | |
| additive) | | | | | | |
| Potassium | — | — | 2000 ppm | 2000 ppm | — | 2000 ppm |
| stearate | | | | | | |
| (alpha | | | | | | |
| nucleation | | | | | | |
| inhibitor) | | | | | | |
| TotalEnergies | — | — | — | — | 5% | 5% |
| 3270 PP | | | | | | |
| TotalEnergies | balance | balance | balance | balance | balance | balance |
| 6575 PP | | | | | | |

DSC tests for the compositions shown in Table 9 were run as follows:
1. Ramp 20° C./min to 210° C. Hold for 5 minutes.
2. Ramp −20° C./min to 50° C. Hold for 1 minutes.
3. Ramp 10° C./min to 120° C. Hold for 15 minutes. This is the 120° C. anneal.
4. Ramp −10° C./min to 23° C. Hold for 1 minute.
5. Ramp 20° C./min to 210° C. Hold for 1 minute.
6. Ramp −20° C./min to 23° C. Hold for 1 minute.
7. Ramp 10° C./min to 130° C. Hold for 15 minutes. This is the 130° C. anneal.
8. Ramp −10° C./min to 23° C. Hold for 1 minute.
9. Ramp 20° C./min to 210° C. Hold for 1 minute.
10. Ramp −20° C./min to 23° C. Hold for 1 minute.
11. Ramp 10° C./min to 140° C. Hold for 15 minutes. This is the 140° C. anneal.
12. Ramp −10° C./min to 23° C. Hold for 1 minute.
13. Ramp 20° C./min to 210° C. Hold for 1 minute.
14. Ramp −20° C./min to 23° C. Hold for 1 minute.
15 Ramp 10° C./min to 150° C. Hold for 15 minutes. This is the 150° C. anneal.
16 Ramp −10° C./min to 23° C. Hold for 1 minute.
17 Ramp 20° C./min to 210° C. Hold for 1 minute.
18 Ramp −20° C./min to 50° C. Hold for 1 minute.
19 Cool to room temperature and end test

### Results

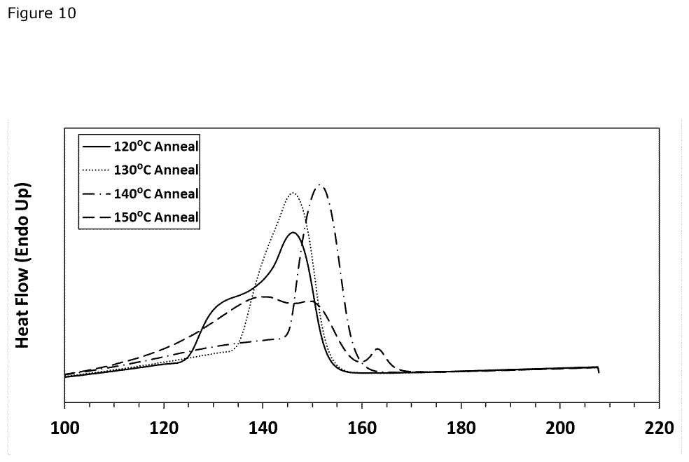

The analysis starts with how the baseline Comparative Example 2 (TotalEnergies 6575) responded to the annealing steps at each annealing temperature. The melting endotherm transformed over the 120° C. to 150° C. annealing temperature range as seen in FIG. 10.
Annealing at 120° C. created a broad lower melting shoulder from about 125° C. to about 135° C., which then rose to a peak at 145° C.
Annealing at 130° C. and 140° C. caused the lower melting shoulder to become less pronounced. It also increased the peak height and pushed out the endset peak temperature, particularly at 140° C. annealing.
Annealing at 150° C. was transformative. A small peak beyond 160° C. was formed, qualitatively matching what is desired in double peak technology. The lower melting peak was bimodal and very broad.

These results illustrate that although some aspects of the melting behavior of Comparative Example 2 (TotalEnergies 6575) are similar to those of Comparative Example 1 (TotalEnergies 3270) as seen in FIG. 3, the random copolymer polypropylene of Comparative Example 2 has some distinguishing features as well. In particular, the formation of a trimodal melting endotherm was not observed in testing Comparative Example 1 TotalEnergies 3270 up to 160° C. annealing temperature. Because results for Comparative Example 2 demonstrated that trimodal melting peaks are possible, the term “multimodal” will be used applied to such behaviour. As used herein “multimodal” means melting endotherms exhibiting two or more melting temperatures.

The complexities of Comparative Example 2 melting endotherms are shown in Table 10. The onset melting temperature rises with higher annealing temperatures temperature up to an annealing temperature of 150° C., after which it drops to just over 111° C. Over the same 120° C. to 140° C. range, the endset melting temperature rose, but not as quickly. As a result, the melting temperature breadth (i.e., the difference between endset Tm and Onset Tm) narrowed. At the annealing temperature of 150° C., the behavior changed. The melting temperature breadth rose to more than 55° C., the endset Tm went to nearly 167° C. and a clear melting peak at more than 160° C. appeared. This melting point of more than 160° C. is important in EPP processing, since crystalline species melting around 160° C. are important to maintaining overall foaming structure as seen in the double peak melting behaviour of polypropylene.

TABLE 10
Onset melting temperature, peak melting temperature(s), endset melting
temperature and melting temperature breadth for Comparative Example 2.

| | | Peak | Peak | Peak | Endset | |
|---|---|---|---|---|---|---|
| | Onset | Melting | Melting | Melting | Melting | Melting |
| Annealing | Melting | Temp. #1 | Temp. #2 | Temp. #3 | Temp. #1 | Temperature |
| Temp. ° C. | Temp. ° C. | ° C. | ° C. | ° C. | ° C. | Breadth ° C. |
| 120 | 124.82 | 145.52 | N/A | N/A | 152.9 | 28.08 |
| 130 | 133.45 | 145.56 | N/A | N/A | 153.0 | 19.55 |
| 140 | 144.32 | 151.54 | N/A | N/A | 158.5 | 14.18 |
| 150 | 111.48 | 139.73 | 148.48 | 163.11 | 166.9 | 55.42 |

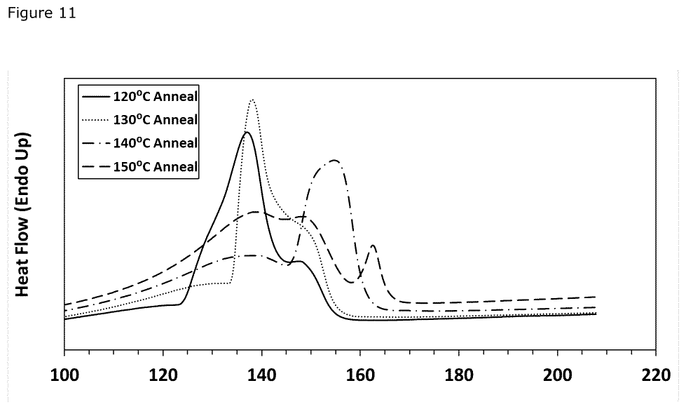

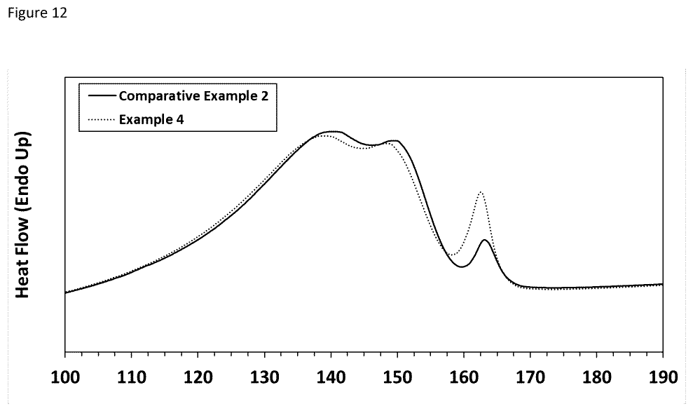

Introducing the beta nucleation additive to TotalEnergies 6575 in Example 4 created additional melting endotherms. This shows that there are strong interactions present (FIG. 11). Qualitative observations on Example 4 versus the Comparative Example 2 baseline include:
A more pronounced low melting peak/shoulder in Example 4.
A broader melting endotherm range at 130° C. and 140° C. in Example 4. This implies a more robust processing window for EPP.
Annealing at 150° C. produced a more pronounced high melting peak above 160° C. (FIG. 12).

These features collectively should be attractive in processes using annealing such as EPP, since including the beta nucleation additive changed the melting behavior. Furthermore, forming more higher melting species at elevated annealing temperatures ensures crystalline species exist to help maintain foaming structure in EPP.

The complexities of the Example 4 melting endotherms are shown in Table 11. Unlike with Comparative Example 2, three of the four annealing temperatures produced multimodal melting endotherms. The peak melting temperature tended to be lower in Example 4 than in Comparative Example 2. In addition, the endset melting temperature of Example 4 tended to be higher. As a result, the desirable melting temperature breadth of Example 4 was increased over the range of annealing temperatures tested.

TABLE 11
Onset melting temperature, peak melting temperature(s), endset melting
temperature and melting temperature breadth for Example 4.

| | | Peak | Peak | Peak | Endset | |
|---|---|---|---|---|---|---|
| | Onset | Melting | Melting | Melting | Melting | Melting |
| Annealing | Melting | Temp. #1 | Temp. #2 | Temp. #3 | Temp. #1 | Temperature |
| Temp. ° C. | Temp. ° C. | ° C. | ° C. | ° C. | ° C. | Breadth ° C. |
| 120 | 124.02 | 136.05 | 147.56 | N/A | 154.8 | 30.8 |
| 130 | 133.22 | 137.45 | N/A | N/A | 155.0 | 21.8 |
| 140 | 109.10 | 138.86 | 154.12 | N/A | 161. | 51.9 |
| 150 | 110.26 | 138.53 | 148.34 | 162.55 | 166.2 | 55.9 |

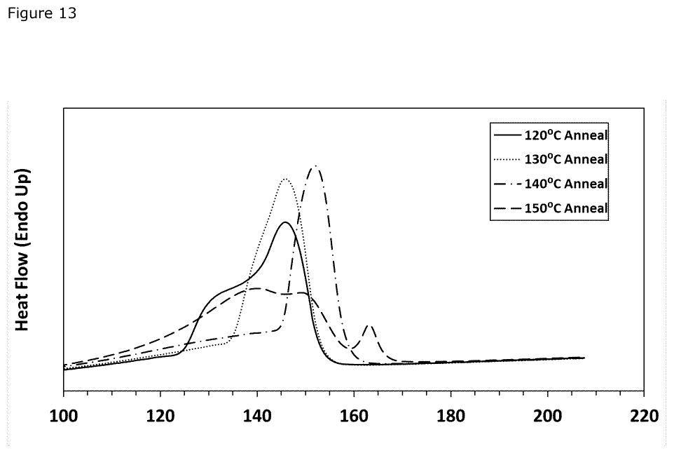

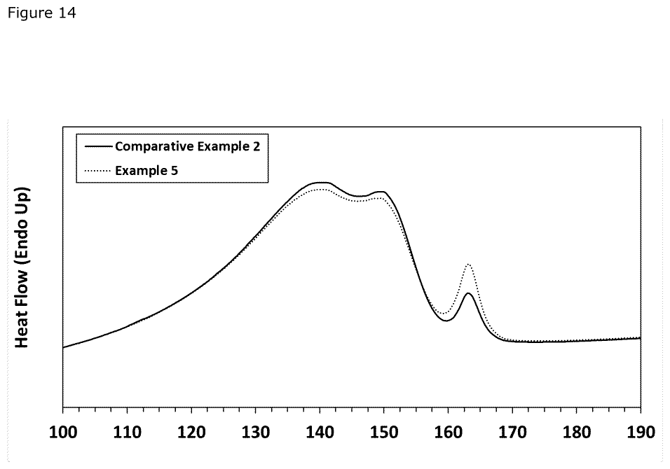

Example 5 showed that introducing the alpha nucleation inhibitor into TotalEnergies 6575 had a smaller effect than the beta nucleation additive effect (FIG. 13). Qualitative observations on Example 5 compared to Comparative Example 2 baseline appear nearly identical with one exception. Annealing Example 5 at 150° C. yielded a more pronounced high melting peak greater than 160° C. (FIG. 14). For some EPP processes this might be attractive. It suggests that RCP with alpha nucleation inhibitor is likely to process very similarly to standard RCP grades, but having more of the high melting species needed for maintaining EPP foaming structure.

The Example 5 melting endotherms data are shown in Table 12. The data are nearly identical to Comparative Example 2. This result is encouraging as it illustrates the DSC testing technique has superb reproducibility. It also gives strong confidence that the larger (greater than 160° C.) melting peak shown in FIG. 14 is genuine and not a testing artifact.

TABLE 12
Onset melting temperature, peak melting temperature(s), endset melting
temperature and melting temperature breadth for Example 5 N21053-3.

| | | Peak | Peak | Peak | Endset | |
|---|---|---|---|---|---|---|
| | Onset | Melting | Melting | Melting | Melting | Melting |
| Annealing | Melting | Temp. #1 | Temp. #2 | Temp. #3 | Temp. #1 | Temperature |
| Temp. ° C. | Temp. ° C. | ° C. | ° C. | ° C. | ° C. | Breadth ° C. |
| 120 | 124.54 | 145.75 | N/A | N/A | 153.1 | 28.6 |
| 130 | 133.59 | 145.78 | N/A | N/A | 153.1 | 19.5 |
| 140 | 144.33 | 151.90 | N/A | N/A | 158.5 | 14.2 |
| 150 | 118.84 | 139.68 | 149.29 | 163.18 | 166.9 | 56.1 |

Example 6 which combined the alpha nucleation inhibitor and the beta nucleation additive in the TotalEnergies 6575 had a synergistic effect on melting behavior (FIG. 12). Qualitative observations on Example 6 versus Comparative Example 2 include:
All DSC traces exhibited multimodal melting exotherms.
A more pronounced low melting peak/shoulder was seen.
A broader melting endotherm range at 130° C. and 140° C. was seen. This provides a desirable broader processing window for EPP.

As with the Example 4 and Example 5 compositions, the Example 6 composition when annealed at 150° C. yielded a more pronounced high melting peak above 160° C. (FIG. 13).

The overall trends of Example 6 are similar to Example 4 but are not a direct duplicate; the alpha nucleation inhibitor together with the beta nucleation additive provided different melting behavior than either alone.

The Example 6 melting endotherm data shown in Table 13 are similar to the behavior of Example 4. The melting temperature breadth is very similar at each annealing temperature, as are most peak melting temperatures. The melting behavior is different than the neat Comparative Example 2.

TABLE 13
Onset melting temperature, peak melting temperature(s), endset melting
temperature and melting temperature breadth for Example 6.

| | | Peak | Peak | Peak | Endset | |
|---|---|---|---|---|---|---|
| | Onset | Melting | Melting | Melting | Melting | Melting |
| Annealing | Melting | Temp. #1 | Temp. #2 | Temp. #3 | Temp. #1 | Temperature |
| Temp. ° C. | Temp. ° C. | ° C. | ° C. | ° C. | ° C. | Breadth ° C. |
| 120 | 123.71 | 135.87 | 147.10 | N/A | 153.6 | 29.9 |
| 130 | 133.02 | 137.97 | 146.57 | N/A | 155.1 | 22.1 |
| 140 | 108.53 | 139.48 | 152.31 | N/A | 161.1 | 52.6 |
| 150 | 111.77 | 139.27 | 149.18 | 162.93 | 167.0 | 55.2 |

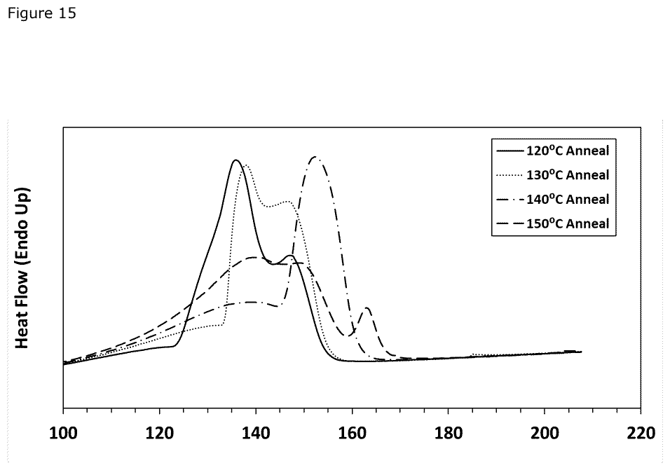

FIG. 14 shows second melt DSC traces of Example 4 and Example 6 after 130° C. annealing. FIG. 14 shows how the beta nucleation additive and alpha nucleation inhibitor work together compared to just the beta nucleation additive alone in TotalEnergies 6575. Example 6 has a lower first peak and forms a distinct second peak as shown in FIG. 15. This result is counter-intuitive; a skilled person would not have expected that adding an alpha nucleation inhibitor would enhance the formation of higher melting species, since the alpha crystallites are the higher melting species in polypropylene.

In contrast, Example 4 only has a pronounced shoulder rather than a distinct second peak (i.e., a tangent line after the first peak never equals zero for a local minimum which would provide a mathematically defined demarcation between the first and second peaks).

In further experiments, 5% of a high crystallinity polypropylene, TotalEnergies 3270 was compounded into the TotalEnergies 6575 as a resin modifier to make Example 7.

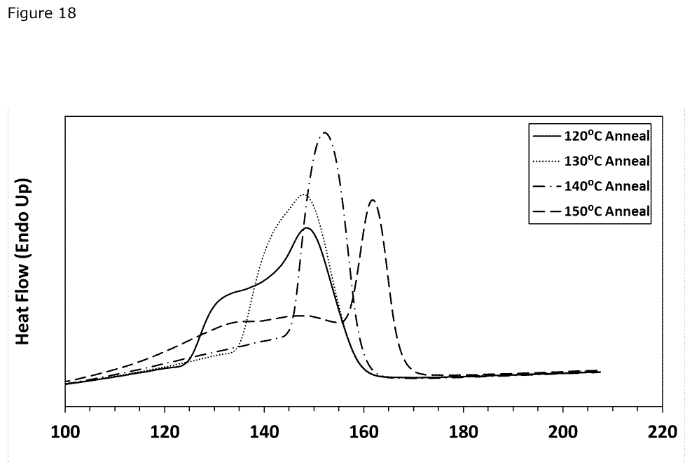

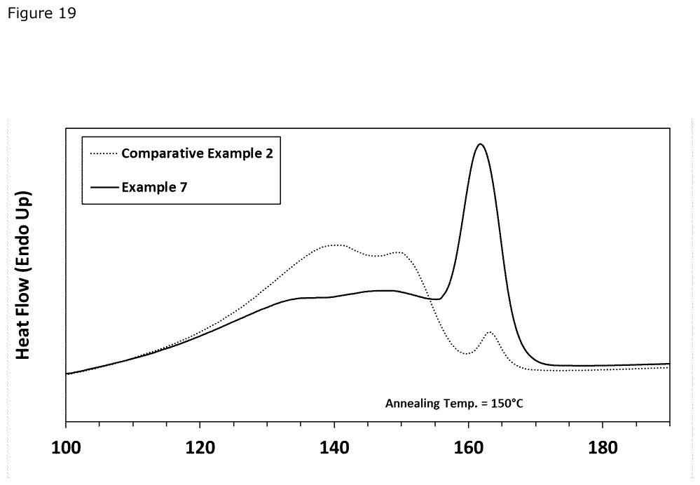

Introducing 5% TotalEnergies 3270 with TotalEnergies 6575 can be seen to have an effect on the melting behaviour after at 150° C. annealing (FIG. 18, FIG. 19). The high melting peak greater than 160° C. dominates the shape of the DSC trace. Therefore, small additions of a high crystallinity PP such as TotalEnergies 3270 enhanced this high melting peak size.

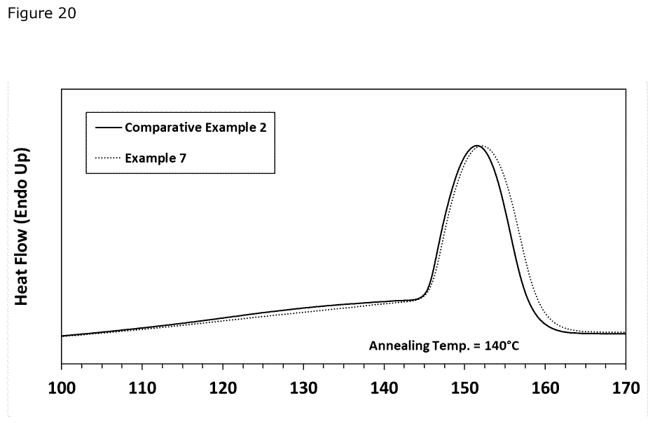

Other effects of adding the high crystallinity polypropylene are as follows. After annealing at 140° C., the addition of the high crystallinity polypropylene created a shift towards higher melting species (FIG. 20). This shift to higher temperatures is duplicated at lower annealing temperatures as well. Such behavior could prove useful for applications outside EPP, such as medical applications, where articles need to be autoclaved at high temperatures without part distortion.

The addition of 5% TotalEnergies 3270 is shown in Table 14. The most significant was to shift the endset melting temperature higher. This feature by itself is useful since it provides a higher annealing temperature without eliminating high melting crystallites. Such a feature could provide a more robust annealing temperature range in EPP processes. This shift increases melting temperature breadth as well since the onset temperature tends to remain similar to that of the base TotalEnergies 6575 resin.

TABLE 14
onset melting temperature, peak melting temperature(s), endset melting
temperature and melting temperature breadth for Example 7.

| | | Peak | Peak | Peak | Endset | |
|---|---|---|---|---|---|---|
| | Onset | Melting | Melting | Melting | Melting | Melting |
| Annealing | Melting | Temp. #1 | Temp. #2 | Temp. #3 | Temp. #1 | Temperature |
| Temp. ° C. | Temp. ° C. | ° C. | ° C. | ° C. | ° C. | Breadth ° C. |
| 120 | 122.92 | 148.45 | N/A | N/A | 159.1 | 36.2 |
| 130 | 133.38 | 147.87 | N/A | N/A | 158.2 | 24.8 |
| 140 | 144.64 | 152.11 | N/A | N/A | 159.9 | 15.3 |
| 150 | 108.86 | 136.54 | 147.6 | 161.8 | 167.8 | 58.9 |

Next, Example 8 was compounded with 5% TotalEnergies 3270 and 2000 ppm alpha nucleation inhibitor. If there was no complementary behavior, Example 8 should mirror the performance of Example 7. Excursions from Example 7 would support a synergistic effect, particularly if they are qualitatively similar to trends from other of Example 4-6 compounds.

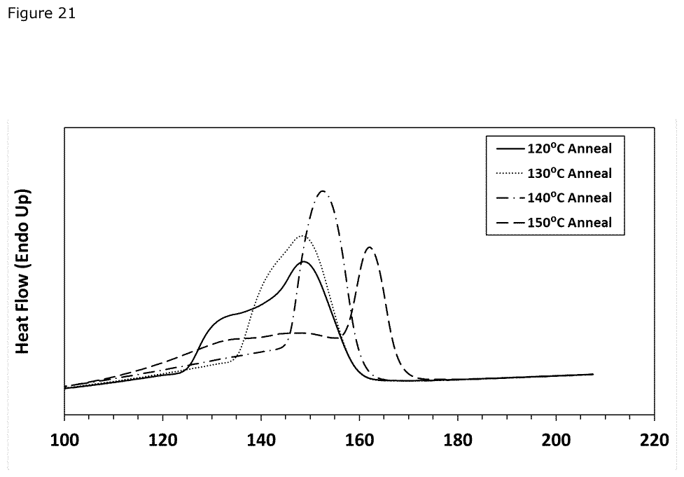

The initial DSC results for Example 8 followed the general pattern found with Example 7N21053-5 (FIG. 18). Example 8 yielded a very strong melting peak at greater than 160° C. when annealed at 150° C. (FIG. 21) At lower annealing temperatures, the peak melting temperature moved lower and a lower melting shoulder developed.

There was a subtle but consistent effect in formulating TotalEnergies 6575 with TotalEnergies 3270 and the beta nucleation inhibitor together as seen in Example 8 and FIG. 21. The endset melting temperature was consistently higher than the Example 7 (TotalEnergies 6575/TotalEnergies 3270-95/5%) composition. The onset melting temperature remained the same between Example 7 and Example 8, but the Example 8 formulation had an increased melting temperature breadth as well.

TABLE 15
Onset melting temperature, peak melting temperature(s), endset melting
temperature and melting temperature breadth for Example 8.

| | | Peak | Peak | Peak | Endset | |
|---|---|---|---|---|---|---|
| | Onset | Melting | Melting | Melting | Melting | Melting |
| Annealing | Melting | Temp. #1 | Temp. #2 | Temp. #3 | Temp. #1 | Temperature |
| Temp. ° C. | Temp. ° C. | ° C. | ° C. | ° C. | ° C. | Breadth ° C. |
| 120 | 122.97 | 148.52 | N/A | N/A | 159.7 | 36.7 |
| 130 | 133.41 | 148.25 | N/A | N/A | 159.0 | 25.6 |
| 140 | 144.53 | 152.58 | N/A | N/A | 160.5 | 16.0 |
| 150 | 108.86 | 136.49 | 148.44 | 162.06 | 168.4 | 59.5 |

TABLE 16
Endset melting temperature shifts with the addition of 2000 ppm of alpha nucleation
inhibitor (Example 5) and/or 5% TotalEnergies 3270 (Examples 7 and 8).

| | | | Example | | | |
|---|---|---|---|---|---|---|
| | | | 7 Endset | | | |
| | | | Tm shift | | | Example 8 |
| | Comp. | | ° C. | | | Endset Tm |
| | Example | | relative | | | shift ° C. |
| Annealing | 2 | Example | to Comp | Example 5 | Example 8 | relative to |
| temp. ° C. | ° C. | 7 | Ex. 2 | ° C. | ° C. | Example 5 |
| 120 | 152.9 | 159.1 | 6.2 | 153.1 | 159.7 | 6.6 |
| 130 | 153.0 | 158.2 | 5.2 | 153.1 | 159.0 | 5.9 |
| 140 | 158.5 | 159.9 | 1.4 | 158.5 | 160.5 | 2.0 |
| 150 | 166.9 | 167.8 | 0.9 | 166.9 | 168.4 | 1.5 |
| | | | Example | | | |
| | | | 5 Endset | | | |
| | | | Tm Shift | | | Example 8 |
| | Comp. | | ° C. | | | Endset Tm |
| | Example | | relative | | | shift ° C. |
| Annealing | 2 | Example | to Comp. | Example 7 | Example 8 | relative to |
| temp. ° C. | ° C. | 5 | Ex 2 | ° C. | ° C. | Example 7 |
| 120 | 152.9 | 153.1 | 0.2 | 159.1 | 159.7 | 0.6 |
| 130 | 153.0 | 153.1 | 0.1 | 158.2 | 159.0 | 0.6 |
| 140 | 158.5 | 158.5 | 0.0 | 159.9 | 160.5 | 0.8 |
| 150 | 166.9 | 166.9 | 0.0 | 167.8 | 168.4 | 0.6 |

The present disclosure relates to modification of a random copolymer polypropylene (RCP) melting behavior by annealing at various temperature together with the addition of small amounts of beta nucleation additives, alpha nucleation inhibitors and high crystallinity polypropylene. Through using this additives/modifiers, beneficial features were achieved:
More higher melting (≥160° C.) melting species were increased after annealing, as shown visually in the size of the melting endotherm peaks compared to the neat RCP baseline.
The endset melting temperature was generally shifted to a higher temperature.
Multimodal melting endotherms were generated versus the neat RCP baseline.
Melting temperature breadth, as defined by the endset melting temperature minus the onset melting temperature, was increased.

Taken together, these results demonstrate that RCP thermal performance was improved to better suit end-use applications having a high temperature conditioning/annealing step. The production of expanded polypropylene (EPP) is one commercial example where this is practiced. Other applications are in articles subjected to high temperature sterilization (such as autoclave and steam sterilization) and in other polypropylene processing techniques where an article is reheated for further shaping (such as thermoforming of sheet or injection stretch blow molding of preforms).

In some embodiments, the invention herein can be construed as excluding any element or process that does not materially affect the basic and novel characteristics of the composition or process. Additionally, in some embodiments, the invention can be construed as excluding any element or process not specified herein.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A method of preparing a foamable polypropylene composition comprising:
a) compounding a first polypropylene comprising, as polymerized monomers, at least 90 wt. % propylene by weight of the first polypropylene with an alpha nucleation inhibitor to form a polypropylene blend;
b) compounding the polypropylene blend with a blowing agent to form a pre-annealed polypropylene composition; and
c) annealing the pre-annealed polypropylene composition at an annealing temperature Ta for an annealing time ta to form the foamable polypropylene composition, wherein the foamable polypropylene composition has a first melting peak T1 and a second melting peak T2 as measured by differential scanning calorimetry at a heating rate of 20° C. per minute.

2. The method of claim 1, wherein the pre-annealed polypropylene composition has a third melting peak T3 as measured by differential scanning calorimetry at a heating rate of 20° C. per minute.

3. The method of claim 1, wherein step a) further comprises compounding a beta nucleation additive with the first polypropylene and the alpha nucleation inhibitor to form the polypropylene blend.

4. The method of claim 3, wherein at least one of the beta nucleation additive and the alpha nucleation inhibitor is in the form of a masterbatch.

5. The method of claim 3, wherein the beta nucleation additive comprises one or more members selected from a group consisting of gamma-crystalline form of quinacridone dye; aluminum salt of 6-quinazirin sulfonic acid; disodium salt o-phthalic acid; isophthalic acid or derivative thereof; terephthalic acid or derivative thereof; N′,N′-dicyclohexyl-2,6-naphthalene dicarboxamide; a blend of organic dibasic acid with oxide, hydroxide, or acid of Group II metal; and a combination thereof.

6. The method of claim 1, wherein step a) and step b) are performed in a single compounding operation.

7. The method of claim 1, wherein step b) further comprises pelletizing the pre-annealed polypropylene composition.

8. The method of claim 1, wherein the alpha nucleation inhibitor comprises potassium stearate.

9. The method of claim 1, wherein step a) further comprises compounding up to 5 wt. % by weight of the foamable polypropylene composition a second polypropylene, wherein the second polypropylene is different from the first polypropylene and comprises, as polymerized monomers, at least 99 wt. % propylene by weight of the second polypropylene and at least 50 wt. % crystallinity by weight of the second polypropylene.

10. The method of claim 9, wherein the second polypropylene comprises, as a polymerized monomer, i) up to 1 wt. % by weight the second polypropylene, and ii) one or more members selected from a group consisting of ethylene, butene, pentene, hexene, and a combination thereof.

11. The method of claim 1, wherein the first polypropylene comprises isotactic polypropylene.

12. The method of claim 1, wherein the first polypropylene comprises syndiotactic polypropylene.

13. The method of claim 1, wherein the first polypropylene comprises, as a polymerized monomer, i) up to 6 wt. % by weight the first polypropylene, and ii) one or more members selected from a group consisting of ethylene, butene, pentene, hexene, and a combination thereof.

14. The method of claim 1, wherein the foamable polypropylene composition has a crystallinity of at least 25 wt. % based on the total weight of the first polypropylene, as measured by NMR.

15. The method of claim 1, wherein the foamable polypropylene is in the form of a masterbatch, and wherein the alpha nucleation inhibitor and the beta nucleation additive together comprise from 0.1 to 80 wt. % based on the total weight of the foamable polypropylene composition.

16. The method of claim 1, wherein the annealing temperature Ta is at least 90° C. and no greater than 200° C.

17. The method of claim 1, wherein the first polypropylene has a melt flow index from 0.1 to 500 g/10 minutes.

18. The method of claim 1, wherein the first polypropylene has a polydispersity of at least 2.0 and no greater than 15.0.

19. The method of claim 1, wherein the first polypropylene has an average molecular weight of at least 10,000 g/mol and no greater than 1,000,000 g/mol.

20. The method of claim 1, wherein the first polypropylene is a homopolymer or a random copolymer of propylene.
